(19) United States
(12) Patent Application Publication
(10) Pub. No.: US 2016/0057596 A1
(43) Pub. Date: Feb. 25, 2016

(54) DISTRESS BEACON

(71) Applicants: JAN THOMPSON, Edinburgh (GB); Paul Thompson, Edinburgh (GB)

(72) Inventors: JAN THOMPSON, Edinburgh (GB); Paul Thompson, Edinburgh (GB)

(73) Assignee: TELECOMMUNICATION SYSTEMS, INC., Annapolis, MD (US)

(21) Appl. No.: 14/521,273

(22) Filed: Oct. 22, 2014

Related U.S. Application Data
(60) Provisional application No. 62/041,469, filed on Aug. 25, 2014.

(51) Int. Cl. H04W 4/22; H04W 4/06; H04W 4/02

(52) U.S. Cl. CPC H04W 4/22; H04W 4/02; H04W 4/06

(57) ABSTRACT

A mobile device can include a distress application configured to activate a distress beacon that is broadcast as a radio frequency (RF) signal on a plurality of different protocols. Each of the plurality of different protocols can employ a different frequency band.

### CROSS-REFERENCE TO RELATED APPLICATION

This application claims the benefit of priority to U.S. Provisional Application No. 62/041,469 filed on Aug. 25, 2014, and entitled MISSING PERSON DISTRESS BEACONING, the entirety of which is herein incorporated by reference.

### TECHNICAL FIELD

This disclosure relates to broadcasting a distress beacon.

### BACKGROUND

A beacon is an intentionally conspicuous signal output by a device designed to attract attention to a specific location. Beacons can also be combined with other indicators to provide important information, such as the status of an entity. In wireless networks, a beacon can be implemented as a type of frame which is sent by an access point (or WiFi router), to indicate that the access point is turned on.

A Public-Safety Answering Point (PSAP), sometimes called a “Public-Safety Access Point”, can be implemented as a call center responsible for answering calls (or electronic messages) to an emergency telephone number for police, firefighting, and ambulance services. Trained operators are usually responsible for dispatching these emergency services.

### SUMMARY

One example relates to a mobile device that can include a memory configured to store machine readable instructions and data. The mobile device can also include a processing unit configured to access the memory and execute the machine readable instructions. The machine readable instructions can include a distress application configured to activate a distress beacon that is broadcast as a radio frequency (RF) signal on a plurality of different protocols. Each of the plurality of different protocols can employ a different frequency band.

Another example relates to a non-transitory machine readable medium having machine executable instructions. The machine executable instructions can include a distress application configured to control device settings of a mobile device to allow location information for the mobile device to be broadcast. The distress application can also be configured to activate a distress beacon. The distress beacon can be broadcast on a plurality of different wireless communication protocols. The distress beacon can include information encoded therein that characterizes the location information for the mobile device.

Yet another example relates to a method that includes receiving a request for activation of a distress beacon. The method can also include retrieving location information characterizing a location of a mobile device. The method can further include broadcasting the distress beacon on a selected set of wireless output protocols in response to the receiving. The distress beacon can include data characterizing the location information of the mobile device.

### BRIEF DESCRIPTION OF THE DRAWINGS

FIG. 1 illustrates an example of a system for broadcasting a distress beacon.

FIG. 2 illustrates an example of a mobile device that can broadcast a distress beacon.

FIG. 3 illustrates a flowchart of an example method for broadcasting a distress beacon.

### DETAILED DESCRIPTION

Systems and method to implement a distress application configured to broadcast (e.g., output) a distress beacon from a mobile device are described. The distress beacon can be broadcast from a mobile device in response to local user input at the mobile device or in response to a command from an external system (e.g., a remote system). Typically, the distress beacon can be activated when a user of the mobile device is in distress (e.g., after a vehicle accident) or when the user of the mobile device is suspected by another person (e.g., next-of-kin) to be in distress. The distress application can be configured to deactivate (e.g., turn off) privacy settings on the mobile device that may otherwise prevent location information being transmitted from the mobile device. Accordingly, the distress beacon can include (among other things) identification of a user of the mobile device and the location information of the mobile device.

Moreover, the distress beacon can be broadcast on a plurality of different protocols. Such protocols can include a cellular data protocol, a WiFi protocol and a Peer-to-Peer (e.g., Bluetooth) protocol. By broadcasting the distress beacon on the plurality of different protocols, the likelihood that a wireless device (e.g., a cell tower, a WiFi hotspot or another mobile device) will detect the distress beacon is increased, such that appropriate authorities (e.g., emergency services) can be contacted and personnel can be dispatched to the location of the mobile device.

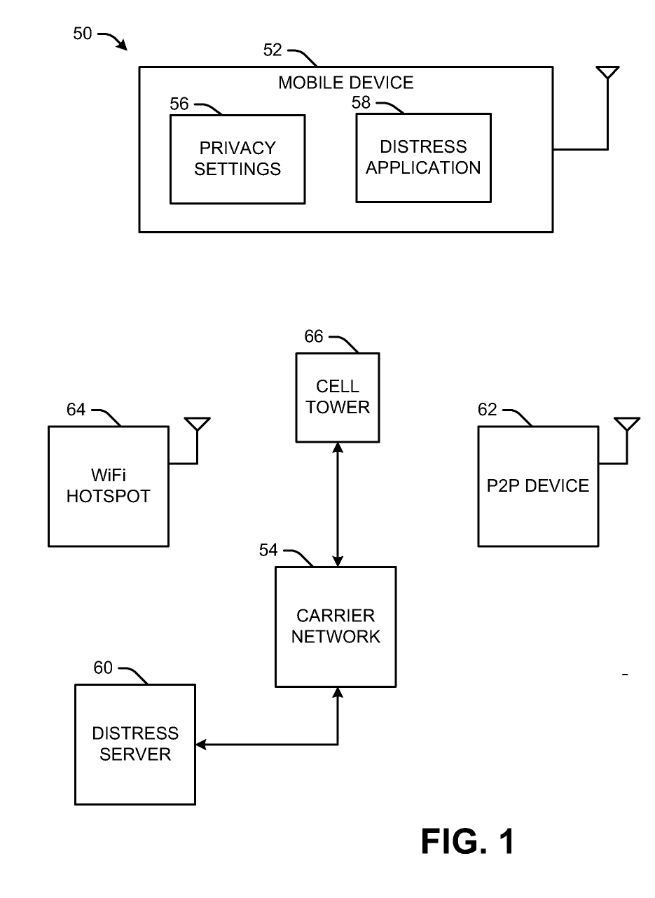

FIG. 1 illustrates an example of a system 50 for broadcasting a distress beacon (e.g., a “find me” beacon) from a mobile device 52. The mobile device 52 could be, for example, a smart phone, a feature phone, a tablet computer, etc. The mobile device 52 can communicate with a carrier network 54. The carrier network 54 can be implemented, for example, as a telecommunications carrier network. In some examples, the mobile device 52 may be a subscriber to the carrier network 54. In other examples, the mobile device 52 may access the carrier network 54 through a “roaming” feature.

The mobile device 52 can include privacy settings 56 that control privacy options of the mobile device 52. The privacy settings 56 can control, for example, dissemination of location information of the mobile device 52. The location information can be, for example, latitude and longitude coordinates characterizing a physical location of the mobile device 52. For instance, in some situations, the mobile device 52 can include location detection equipment, such as a global navigation satellite system (GNSS) that can be configured to receive signals from satellites that can be employed by the mobile device 52 to determine the location information for the mobile device 52. The GNSS could be implemented, for example, as a Global Positioning System (GPS), GLONASS, etc. In other examples, the mobile device 52 can be configured to receive multiple signals from node on carrier networks (e.g., cell towers), wherein the location information of the mobile device 52 can determined via triangulation techniques. In the present examples, it is presumed that if privacy settings 56 are turned on (or activated), that the mobile device 52 is prevented from transmitting the location information to an external source. In contrast, in the present examples, it is presumed that if the privacy settings 56 are turned off (or deactivated), the mobile device 52 will transmit the location information to an external device upon request and/or the mobile device 52 can transmit the location information without a request (e.g., during a push operation).

The mobile device can be configured to activate a distress beacon in response to user input. For example, in the event that a user of the mobile device 52 is in an accident (e.g., a vehicle accident), the user of the mobile device 52 can execute a distress application 58 via a graphical user interface (GUI) of the mobile device 52 that can activate the distress beacon. Alternatively, a user pre-registered with a distress server 60 associated with the mobile device 52 can initiate activation of the distress beacon remotely. The pre-registered user can be personally associated with the user of the mobile device 52. For example, the pre-registered user can be an emergency contact, a family member (e.g., next-of-kin), an employer, etc. of the user of the mobile device 52. In such a situation, the pre-registered user can log-on to the distress server 60 (e.g., via a web page or a dedicated client application) and request that the distress beacon be activated. In response, the distress server 60 can contact the carrier network 54 communicating with the mobile device 52 and provide the mobile device 52 with a command to request that the distress application 58 activate the distress beacon.

In either situation, the distress application 58 can cause the mobile device 52 to turn off (e.g., deactivate) the privacy settings 56. Stated differently, the distress application 58 can override the privacy settings 56. Additionally, the distress application 58 can cause the mobile device 52 to wirelessly broadcast the distress beacon. The distress beacon can be implemented as a radio frequency (RF) pulse that is periodically broadcast with data encoded therein. The data encoded in the distress beacon can include a unique identifier (ID) of the mobile device 52. The unique ID of the mobile device 52 can be implemented, for example, as a Mobile Station ID (MSID) (e.g., a Mobile Identification Number) an International Mobile Subscriber Identity (IMSI), etc. The data encoded in the wireless distress beacon can also include a name of the user of the mobile device 52, a cell-ID of a cell that is currently serving the mobile device 52, the location information of the mobile device 52, etc. The wireless distress beacon can be broadcast on every available communications protocol or some subset thereof. Such communications protocols can include but are not limited to a cellular data protocol, the WiFi protocol (e.g., 802.11b, 802.11g, 802.11n and/or 802.11ac) and a Peer-to-Peer (P2P) protocol (e.g., Bluetooth). In some examples, the distress beacon can be sent as a Commercial Mobile Alert System (CMAS) message, which can also be referred to as a Wireless Emergency Alert (WEA) message.

The distress beacon can be detected by a wireless device that is within range of the mobile device 52. The range between the mobile device 52 and the wireless device that detects the distress beacon can vary based on an output power (e.g., strength) of the distress beacon and the protocol employed to broadcast the distress beacon. A wireless device that detects the distress beacon can be configured to automatically or manually contact the appropriate authorities. In some examples, the wireless device can contact the appropriate authorities using a different protocol (or the same protocol) than the protocol employed by the detected distress beacon. Such appropriate authorities can include, but is not limited to, a Public Safety Answer Point (PSAP), a police station, a fire station, etc. The wireless device can relay the information encoded in the distress beacon to the appropriate authorities, such that proper action can be taken by these authorities. Such proper action can include, dispatching personnel to a location characterized in the location information encoded in the distress beacon, contacting others (e.g., next of kin, or other personal associates of the user of the mobile device 52), etc.

The wireless device that detects the distress beacon could be, for example, a P2P device 62, such as another mobile device 52 (e.g., another smart phone or feature phone) that can be employed by another user. In such a situation, the P2P device 62 can detect a portion of the distress beacon that is being broadcast via the P2P protocol (e.g., Bluetooth). The user of the P2P mobile device 52 can contact the appropriate authorities (e.g., a PSAP) and relay the information in the distress beacon. In other situations, the P2P device 62 may be configured to automatically forward the information encoded in the distress beacon to the appropriate authorities, thereby obviating the need for a human response by the user of the P2P device 62. As noted, in some examples, the appropriate authorities can be contacted through a protocol other than the P2P protocol. For instance, the P2P device 62 may be configured to contact the appropriate authorities using a cellular data protocol in response to detecting the distress beacon via the P2P protocol.

Additionally or alternatively, the wireless device that detects the distress beacon can be a WiFi hotspot 64 (e.g., a WiFi router, a WiFi access point, etc.). In such a situation, the WiFi hotspot 64 can detect a portion of the distress beacon that is being broadcast via the WiFi protocol. The WiFi hotspot 64 can be configured such that the appropriate authorities (e.g., a PSAP) are automatically or manually contacted in response to receipt of the distress beacon. Additionally, the WiFi hotspot 64 can relay the information encoded in the distress beacon to these authorities. In some examples, the WiFi hotspot 64 can contact the appropriate authorities using a public network (e.g., the Internet). In other examples, the WiFi hotspot 64 can be configured to contact the appropriate authorities using a proprietary network (e.g., a proprietary PSAP network).

Additionally or alternatively, the wireless device that detects the distress beacon can be a cell tower 66 (e.g., a cellular antenna) of the carrier network 54 (e.g., a telecommunications carrier network). The carrier network 54 could be, for example, a Fourth Generation (4G) network, a 4G Long Term Evolution Network (4G LTE), a Third Generation (3G) network, a Third Generation Partnership Program (3GPP) network, etc. In such a situation, the carrier network 54 can detect a portion of the distress beacon that is being broadcast via the cellular data protocol. The carrier network 54 can be configured such that the appropriate authorities (e.g., a PSAP) are automatically or manually contacted in response to receipt of the distress beacon. Additionally, the carrier network 54 can relay the information encoded in the distress beacon to these authorities. In some examples, the carrier network 54 can contact the appropriate authorities using a public network (e.g., the Internet). In other examples, the carrier network 54 can be configured to contact the appropriate authorities using a proprietary network. The proprietary network could be, for example, a proprietary PSAP network or a direct link between the carrier network 54 and a PSAP. The mobile device 52 may or may not be a subscriber to the carrier network 54. In some situations, the mobile device 52 may be “roaming” on the carrier network 54. In other situations, the mobile device 52 may not be a subscriber to any carrier network 54.

By employing the system 50, the user of the mobile device 52 can be quickly and efficiently found by the appropriate authorities such that appropriate action can be taken. In particular, the distress beacon can be broadcast by the distress application 58 even if the privacy settings 56 of the mobile device 52 are initially turned on, and would otherwise prohibit the mobile device 52 from outputting certain information (e.g., location information). Furthermore, as noted, the request to activate the distress beacon received at the distress application 58 can be provided from a remote station, such that in situations where the user of the mobile device 52 is unconscious, the user of the mobile device 52 can still be found by the appropriate authorities.

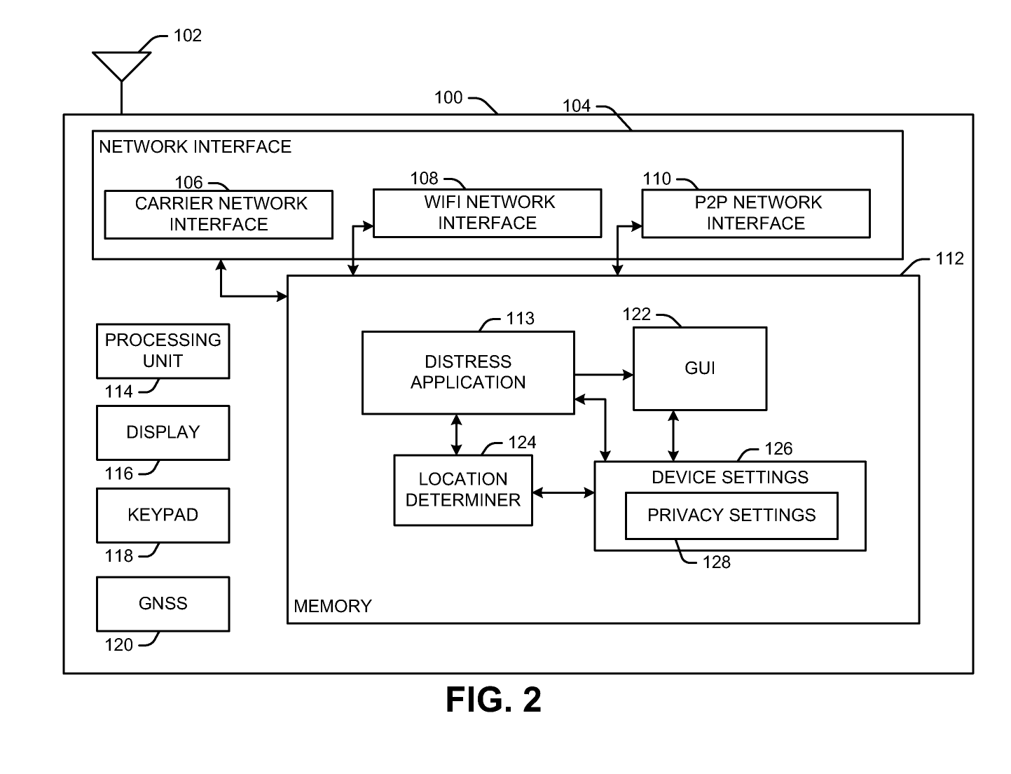

FIG. 2 illustrates an example of a mobile device 100 that could be employed as the mobile device 52 of FIG. 1. The mobile device 100 could be employed, for example, as a smartphone, a feature phone, a tablet computer, etc. The mobile device 100 can include an antenna 102 that can propagate and receive RF signals. The mobile device 100 can also include a network interface 104 that can transmit and receive signals on the antenna 102. The network interface 104 can include interface components that can each be configured to communicate with other wireless devices on different protocols.

For example, the network interface 104 can include a carrier network interface 106 that can communicate with wireless devices via a carrier network (e.g., telecommunications carrier network). In some examples, the carrier network could be a 4G network, a 4G LTE network, a 3G network, a 3GPP network, etc. Additionally, the network interface 104 can include a WiFi network interface 108 that can communicate with WiFi enabled devices, such as WiFi hotspots (e.g., WiFi routers and/or WiFi access points), other mobile devices, etc. The network interface 104 can further include a P2P network interface 110. The P2P network interface can communicate with wireless devices (e.g., other mobile devices) via a P2P protocol, such as Bluetooth.

The mobile device 100 can include a memory 112 configured to store machine readable instructions and data. The mobile device 100 can also include a processing unit 114 configured to access the memory 112 and to execute the machine readable instructions. The processing unit 114 can include, for example, one or more processor cores. The mobile device 100 can include a display 116 that can provide output. In some examples, the display 116 can be implemented as a touch screen that can receive user input. Additionally or alternatively, the mobile device 100 can include a keypad 118 that can include buttons to receive user input. In some examples, the mobile device 100 can include a GNSS component 120 configured to monitor and process satellite signals received at the antenna 102. The GNSS component 120 could be implemented, for example, as a GPS component, a GLONASS component, etc.

The memory 112 can include a GUI 122 that can be configured to receive and process user input provided from a user of the mobile device 100. The memory 112 can include a location determiner 124 that can be configured to determine location information for the mobile device 100. The location information can characterize an estimate of a current location of the mobile device 100. The location information can be represented, for example, as latitude and longitude coordinates. In some situations, the location determiner 124 can receive data stored in satellite signals processed by the GNSS component 120. In other examples, the location determiner 124 can employ triangulation techniques to process signals received at the network interface 104 from other wireless devices with a known (stationary) location to determine the location information.

The memory 112 can include device settings 126 that can be controlled by the GUI 122 (e.g., in response to user input). The device settings 126 can control operations of the mobile device 100. In particular, the device settings 126 can include privacy settings 128 that, when turned on (e.g., activated) can prevent applications executing on the mobile device 100 from outputting (e.g., via the network interface 104) the location information for the mobile device 100. When the privacy settings 128 are off, the location information can be transmitted to other wireless devices in response to requests from applications executing on the mobile device 100.

The memory 112 can include a distress application 113. The distress application 113 can be configured to activate a distress beacon (e.g., a “find me” beacon) in response to user input at the GUI 122. Additionally, the distress application 113 can be configured to activate the distress beacon in response to a distress activation command received from a remote device via the network interface 104. For instance, in some examples, users that are personally associated with the user of the mobile device 100 (e.g., next-of-kin, friends, employers, etc.) can be registered and authorized with a distress server that can send the distress activation command. In such a situation, the distress application 113 can provide the GUI 122 with a message that indicates that the distress beacon has been activated, which message can be output to the user of the mobile device 100. In this manner, the distress beacon can be activated locally (e.g., by the user of the mobile device 100) or remotely (e.g., by the pre-registered user).

To activate the distress beacon, the distress application 113 can control the device settings 126 and turn off (e.g., deactivate) the privacy settings 128 (if needed). Stated differently, the distress application 113 can override the privacy settings 128. Additionally, the distress application 113 can query the location determiner 124 for the location information that characterizes a current location of the mobile device 100. The distress application 113 can select a set of available communication protocols (e.g., cellular data, WiFi and Bluetooth) to broadcast the distress beacon to form a selected set of broadcast protocols. Moreover, the distress application 113 can cause the network interface 104 to broadcast the distress beacon (e.g., an RF signal) at each of the selected broadcast protocols (e.g., the cellular data protocol, the WiFi protocol and the Bluetooth protocol). Each of the selected broadcast protocols can employ different frequency bands. The distress beacon can be a periodic signal pulse with data embedded therein. The data embedded in the distress beacon can include a mobile ID (e.g., an MSID and/or an IMSI), a name of the user, a cell-ID serving the mobile device 100 and the location information for the mobile device 100. In some examples, the distress beacon can be broadcast as a WEA message or a CMAS alert message.

A wireless device, such as a P2P device (e.g., a Bluetooth enabled device), a WiFi hotspot (e.g., a WiFi router and/or WiFi access point) and/or a cell tower of a carrier network can detect the distress beacon, which wireless device can be referred to as a detecting device. The detecting device can be configured to contact the appropriate authorities (e.g., a PSAP) and relay the data encoded in the distress beacon to these authorities such that the user of the mobile device 100 can receive the appropriate assistance (e.g., dispatch of emergency services, contact next of kin, etc.).

By employing the mobile device 100, the emergency services (or other services) can be dispatched quickly without being hindered by the privacy settings 128 of the mobile device 100. Additionally, since, as noted, the pre-registered user can remotely provide a request to the distress application 113 to activate the distress beacon, in some situations, the user may not be conscious (e.g., after a vehicle accident), which could make a traditional emergency phone call (e.g., a “911 call”) impossible. Further, since the distress beacon can be broadcast using a WiFi protocol and/or a P2P protocol (e.g., Bluetooth), in situations where a carrier network is out of range or otherwise unavailable, the distress beacon can still be received at either the WiFi hotpot or a P2P device (e.g., another mobile device of a user passing by the location of the mobile device 100). Therefore, employment of the mobile device 100 can increase the likelihood that the user of the mobile device 100 is found as quickly as possible.

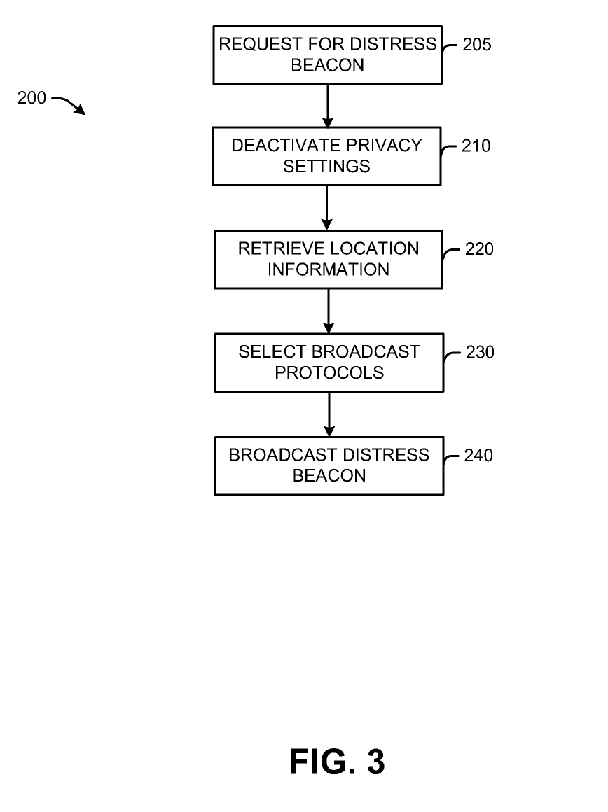

In view of the foregoing structural and functional features described above, example methods will be better appreciated with reference to FIG. 3. While, for purposes of simplicity of explanation, the example methods of FIG. 3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement a method. The example method of FIG. 3 can be implemented as instructions stored in a non-transitory machine-readable medium. The instructions can be accessed by a processing resource (e.g., one or more processor cores) and executed to perform the methods disclosed herein.

FIG. 3 illustrates a flowchart of an example method 200 for broadcasting a distress beacon. The method 200 could be implemented, for example, by a mobile device, such as the mobile device 52 of FIG. 1 and/or the mobile device 100 of FIG. 2. At 205, a distress application (e.g., the distress application 58 of FIG. 1 and/or the distress application 113 of FIG. 2) can receive a request to activate a distress beacon. The request can be received, for example, from a GUI (e.g., the GUI 122 of FIG. 2) in response to user input. Alternatively, the request can be received from an external source (e.g., a distress server). In such a situation, a pre-registered user can remotely request that the distress beacon be activated.

At 210, the distress beacon can deactivate (e.g., turn off) privacy settings of the mobile device. Deactivation of the privacy settings can allow the mobile device to transmit an RF signal to external devices that includes location information for the mobile device. At 220, the distress application can retrieve location information from a location determiner (e.g., the location determiner 124 of FIG. 2). The location information can include latitude and longitude coordinates that characterize a current location of the mobile device. In some examples, the location information can be based on satellite signals received at the mobile device. In other examples, the mobile device can employ triangulation methods to derive the location information based on signals received from multiple cell towers of a carrier network.

At 230, the distress application can select broadcast protocols from a list of wireless communications protocols available at the mobile device. The selected broadcast protocols can include, but are not limited to a cellular data protocol, the WiFi protocol and Bluetooth (or other P2P protocol). At 240, the distress beacon can be activated, such that the distress beacon can be wirelessly broadcast on the selected protocols.

In view of the foregoing structural and functional description, those skilled in the art will appreciate that portions of the systems and method disclosed herein may be embodied as a method, data processing system, or computer program product such as a non-transitory computer readable medium. Accordingly, these portions of the approach disclosed herein may take the form of an entirely hardware embodiment, an entirely software embodiment (e.g., in a non-transitory machine readable medium), or an embodiment combining software and hardware. Furthermore, portions of the systems and method disclosed herein may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processors of a general purpose computer, special purpose computer, or other programmable data processing apparatus (or a combination of devices and circuits) to produce a machine, such that the instructions, which execute via the one or more processors, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

What have been described above are examples. It is, of course, not possible to describe every conceivable combination of structures, components, or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to. The term “based on” means based at least in part on.

What is claimed is:

1. A mobile device comprising:
a memory configured to store machine readable instructions and data; and
a processing unit configured to access the memory and execute the machine readable instructions, the machine readable instructions comprising:
a distress application configured to activate a distress beacon that is broadcast as a radio frequency (RF) signal on a plurality of different protocols, wherein each of the plurality of different protocols employs a different frequency band.

2. The mobile device of claim 1, wherein the distress application is further configured to override privacy settings of the mobile device to allow the mobile device to transmit location information for the mobile device and the distress beacon includes encoded data that characterizes the location information of the mobile device.

3. The mobile device of claim 2, wherein the location information characterizes latitude and longitude coordinates of the mobile device.

4. The mobile device of claim 3, wherein the mobile device further comprises:
a global positioning system configured to receive satellite signals; and
a location determiner configured to determine the location information based on the satellite signals.

5. The mobile device of claim 1, wherein the distress beacon is broadcast on a cellular data protocol.

6. The mobile device of claim 1, wherein the distress beacon is broadcast on a WiFi protocol.

7. The mobile device of claim 1, wherein the distress beacon is broadcast on a Peer-to-Peer protocol.

8. The mobile device of claim 7, wherein the Peer-to-Peer protocol is the Bluetooth protocol.

9. The mobile device of claim 1, wherein the distress beacon is broadcast on a cellular data protocol, a WiFi protocol and a Peer-to-Peer protocol.

10. The mobile device of claim 1, wherein the distress application is further configured to activate the distress beacon in response to user input.

11. The mobile device of claim 1, wherein the distress application is further configured to activate the distress beacon in response to a command received wirelessly at the mobile device.

12. The mobile device of claim 11, wherein the distress application is further configured to override privacy settings of the mobile device to allow the mobile device to transmit location information for the mobile device in response to receipt of the command.

13. The mobile device of claim 1, wherein the distress beacon has information encoded therein, the information characterizing a mobile identifier of the mobile device and a name of a user of the mobile device.

14. The mobile device of claim 13, wherein the information encoded in the distress beacon further characterizes location information of the mobile device.

15. The mobile device of claim 14, wherein the information encoded in the distress beacon further characterizes a cell identifier for a cell in communication with the mobile device.

16. A non-transitory machine readable medium having machine executable instructions, the machine executable instructions comprising a distress application configured to:
control device settings of a mobile device to allow location information for the mobile device to be broadcast; and
activate a distress beacon, wherein the distress beacon is broadcast on a plurality of different wireless communication protocols, wherein the distress beacon includes information encoded therein that characterizes the location information for the mobile device.

17. The non-transitory machine readable medium of claim 16, wherein the plurality of wireless communication protocols comprises at least two of a cellular data protocol, a WiFi protocol and a Peer-to-Peer protocol.

18. The non-transitory machine readable medium of claim 16, wherein the information encoded in the distress beacon further characterizes a name of a user of the distress application.

19. A method comprising:
receiving a request for activation of a distress beacon;
retrieving location information characterizing a location of a mobile device; and
broadcasting the distress beacon on a selected set of wireless broadcast protocols in response to the receiving, wherein the distress beacon includes data characterizing the location information of the mobile device.

20. The method of claim 19, further comprising deactivating privacy settings of the mobile device to allow the broadcasting.
